(19) United States
(12) Patent Application Publication
(10) Pub. No.: US 2026/0050406 A1
(43) Pub. Date: Feb. 19, 2026

(54) CONCEALING MISSING AUDIO DATA PACKETS WITHIN AN AUDIO STREAM

(71) Applicant: Wenger Corporation, Owatonna, MN (US)

(72) Inventors: Glen Farrell, Oceanside, CA (US); Matthew Farstad, Stella, NC (US)

(73) Assignee: Wenger Corporation, Owatonna, MN (US)

(21) Appl. No.: 19/292,250

(22) Filed: Aug. 6, 2025

Related U.S. Application Data
(60) Provisional application No. 63/683,820, filed on Aug. 16, 2024.

(51) Int. Cl. G06F 3/16; G10L 19/16

(52) U.S. Cl. CPC G06F 3/165; G10L 19/167

(57) ABSTRACT

An audio streaming device includes a network interface, a memory storing instructions, and a processor communicatively coupled to the network interface and the memory. The processor is configured to execute the instructions to receive audio data packets from a further audio streaming device, where each audio data packet includes an indicator of the position of the audio data packet within an audio stream. The processor is configured to execute the instructions to buffer the received audio data packets; reconstruct the audio stream based on the indicator of each buffered audio data packet; prior to reconstructing the audio stream, identify whether there is a missing audio data packet within the audio stream based on the indicator of each buffered audio data packet; and in response to identifying a missing audio data packet, conceal the missing audio data packet to mitigate artifacts in the reconstructed audio stream.

### BACKGROUND

Poor connections over a network (e.g., Local Area Network, Wide Area Network, Internet) may lead to temporal gaps where data packets containing audio, such as music, arrive late or not at all, or contain errors. The temporal gaps make it nearly impossible for multiple (e.g., two or more) people to collaborate in real time over a network and keep time with each other while playing live music.

For these and other reasons, there is a need for the present invention.

### SUMMARY

One example of the present disclosure relates to an audio streaming device. The audio streaming device includes a network interface, a memory storing instructions, and a processor communicatively coupled to the network interface and the memory. The processor is configured to execute the instructions to receive audio data packets from a further audio streaming device, where each audio data packet includes an indicator of the position of the audio data packet within an audio stream. The processor is configured to execute the instructions to buffer the received audio data packets; reconstruct the audio stream based on the indicator of each buffered audio data packet; prior to reconstructing the audio stream, identify whether there is a missing audio data packet within the audio stream based on the indicator of each buffered audio data packet; and in response to identifying a missing audio data packet, conceal the missing audio data packet to mitigate artifacts in the reconstructed audio stream.

Another example of the present disclosure relates to a system. The system includes a server and at least two audio streaming devices communicatively coupled to the server. Each audio streaming device is configured to transmit audio data packets for a respective digital audio stream to the server. Each audio data packet includes an indicator of the position of the audio data packet within the respective digital audio stream. The server is configured to buffer the received audio data packets from each of the at least two audio streaming devices in respective buffers; reconstruct each respective digital audio stream based on the indicator of each respective buffered audio data packet; and prior to reconstructing each respective audio stream, identify whether there is a missing audio data packet within the respective digital audio stream based on the indicator of each respective buffered audio data packet. The server is configured to in response to identifying a missing audio data packet within a respective digital audio stream, conceal the missing audio data packet within the respective digital audio stream to mitigate artifacts in the respective reconstructed digital audio stream; combine the at least two reconstructed digital audio streams into a combined digital audio stream; deconstruct the combined digital audio stream into combined audio data packets; and transmit the combined audio data packets to each of the at least two audio streaming devices.

Yet another example of the present disclosure relates to a method. The method includes receiving, via a first device, audio data packets from a second device, each audio data packet including an indicator of the position of the audio data packet within an audio stream. The method includes buffering, via the first device, the received audio data packets. The method includes reconstructing, via the first device, the audio stream based on the indicator of each buffered audio data packet. The method includes prior to reconstructing the audio stream, identifying, via the first device, whether there is a missing audio data packet within the audio stream based on the indicator of each buffered audio data packet. The method includes in response to identifying a missing audio data packet, concealing, via the first device, the missing audio data packet to mitigate artifacts in the reconstructed audio stream.

### BRIEF DESCRIPTION OF THE DRAWINGS

FIGS. 1A and 1B are block diagrams illustrating example audio streaming devices.

FIGS. 2A and 2B are block diagrams illustrating an example processing system for the audio streaming devices of FIGS. 1A and 1B.

FIGS. 3A-3C are flow diagrams illustrating example methods for concealing missing audio data packets in a reconstructed audio stream.

FIG. 3D is a flow diagram illustrating an example method 300d for generating an audio stream.

FIG. 4 is a block diagram illustrating one example of a system for concealing missing audio data packets in a reconstructed audio stream.

FIGS. 5A and 5B are block diagrams illustrating an example processing system for the server of FIG. 4.

FIG. 6 is a flow diagram illustrating one example of a method for concealing missing audio data packets in a reconstructed audio stream.

FIG. 7 is a functional block diagram illustrating an example system for concealing missing audio data packets in a reconstructed audio stream.

FIGS. 8A-8C are block diagrams illustrating example systems and/or methods for reconstructing a packet in the system of FIG. 7.

### DETAILED DESCRIPTION

In the following Detailed Description, reference is made to the accompanying drawings, which form a part hereof, and in which is shown by way of illustration specific examples in which the disclosure may be practiced. It is to be understood that other examples may be utilized and structural or logical changes may be made without departing from the scope of the present disclosure. The following detailed description, therefore, is not to be taken in a limiting sense, and the scope of the present disclosure is defined by the appended claims.

It is to be understood that the features of the various examples described herein may be combined with each other, unless specifically noted otherwise.

As used herein, the term “electrically coupled” is not meant to mean that the elements must be directly coupled together and intervening elements may be provided between the “electrically coupled” elements.

Disclosed herein are systems and devices including processing systems which locally receive analog audio input and/or digital audio input and combine the digital audio input and/or analog audio input with digital audio received over a network, such as the Internet. The processing systems present the combined audio to the user, such as via a speaker or headphones. Because networks vary in quality and are dynamic, occasionally packets are not available in sufficient time to reconstruct the received digital audio stream without errors. Thus, gaps may exist in the data of the digital audio stream, resulting in pops, clicks, or other artifacts in the reconstructed digital audio stream. In addition, jitter or other variations in the timing of the data with respect to a bit clock may produce small errors in the bits encoded or decoded in the digital audio stream.

Accordingly, disclosed herein are systems and devices including components and processes to determine when a packet for a digital audio stream is not available (e.g., lost, late, corrupted, etc.). The packets may be serialized with an identifier that may be used to determine that a packet did not arrive in the proper sequence. Because jitter on a digital link may never be zero, a buffer may be used to address short term changes and to synchronize the packets being received or transmitted in multiple audio streams. Jitter is a short term localized change in the electrical signal composing the data stream that may impact the interpretation of the signal level. If the variation is great enough, the variation may manifest as changes in the delay of a signal through the communication channel.

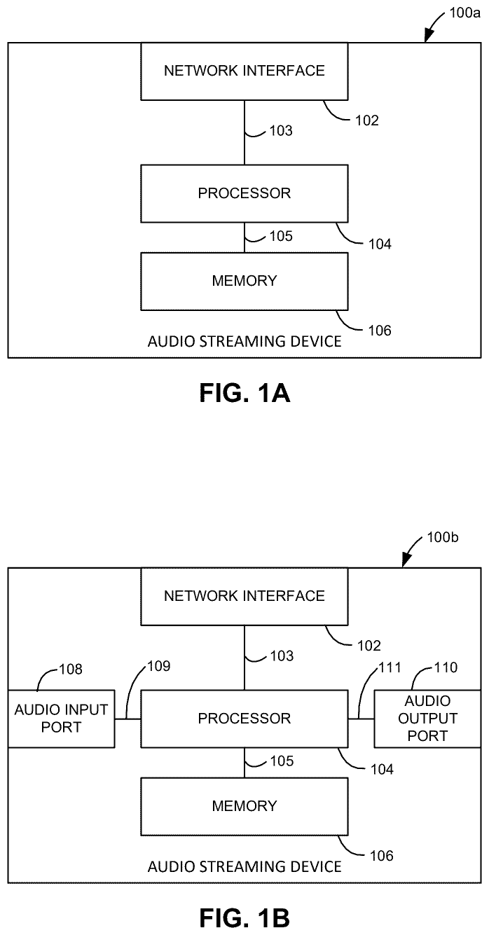

A jitter buffer containing memory to store multiple packets may be used to recall the packets at a precise instant. When it is determined that the variations in the signal path contain late or missing packets, or the packets have multiple errors, packet loss concealment is used to mitigate artifacts in the reconstructed audio stream as disclosed below with reference to the following FIGS. 1A-8C.

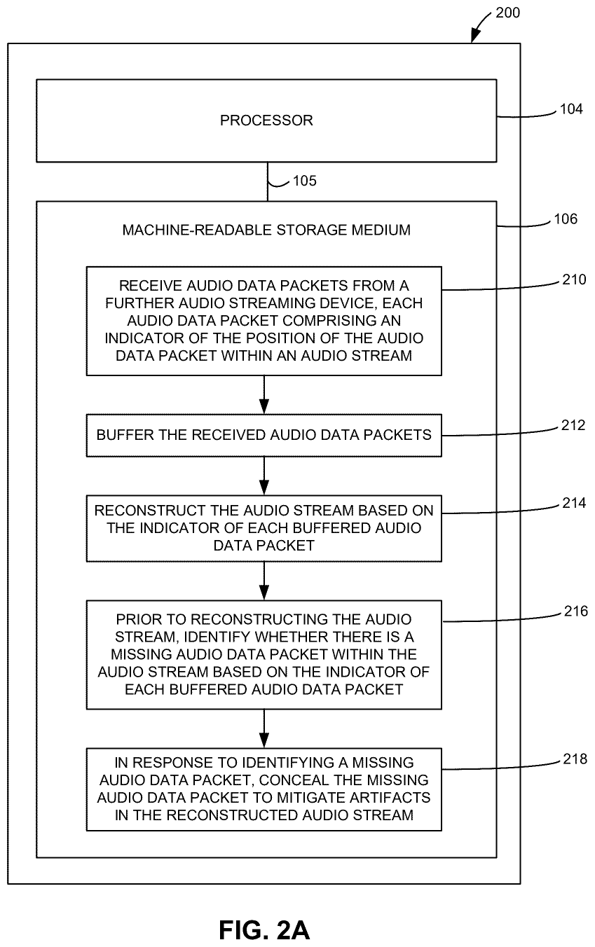

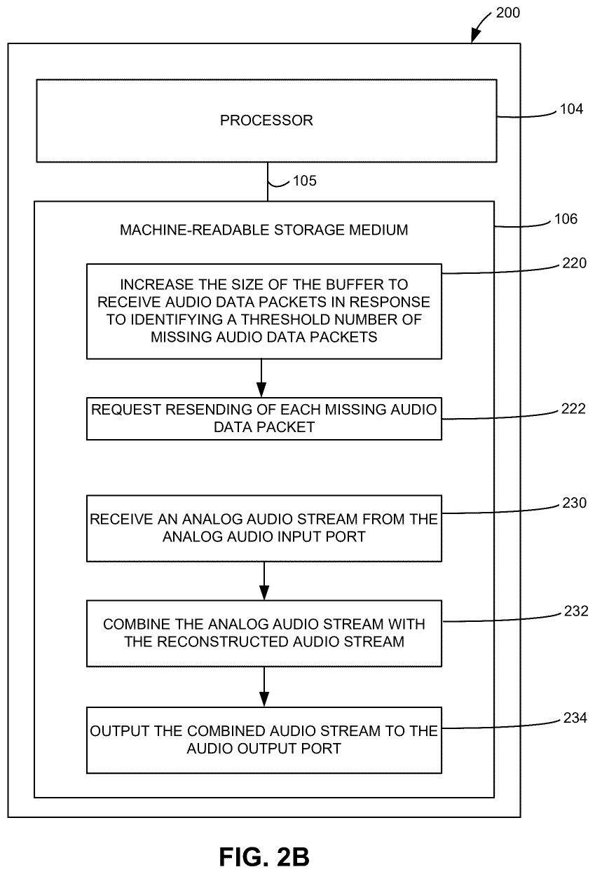

FIG. 1A is a block diagram illustrating one example of an audio streaming device 100a. Audio streaming device 100a includes a network interface 102, a processor 104, and a memory 106. The processor 104 is communicatively coupled to the network interface 102 through a communication path 103 and to the memory 106 through a communication path 105. Network interface 102 is configured to connect the audio streaming device 100a to a network (e.g., Local Area Network, Wide Area Network, Internet). In some examples, network interface 102 may be connected to the network via a cable, such as an Ethernet cable. The processor 104 and memory 106 may provide a processing system for controlling the operation of the audio streaming device 100a as will be described below with reference to FIGS. 2A and 2B.

FIG. 1B is a block diagram illustrating another example of an audio streaming device 100b. Audio streaming device 100b is similar to audio streaming device 100a previously described and illustrated with reference to FIG. 1A, except that audio streaming device 100b further includes an audio input port 108 and an audio output port 110. The audio input port 108 is electrically coupled to the processor 104 through a signal path 109. The audio output port 110 is electrically coupled to the processor 104 through a signal path 111.

In some examples, the audio input port 108 is an analog audio input port configured to receive an analog audio stream from a device (e.g., musical instrument, microphone, etc.) plugged into the audio input port 108. The analog audio stream might be converted into a digital audio stream by the processor 104 and transmitted over the network connected to the network interface 102.

In some examples, the audio output port 110 is an analog audio output port configured to output an analog audio stream to speakers (e.g., headphones) plugged into the audio output port 110. The processor 104 might receive a digital audio stream via the network connected to network interface 102, combine the digital audio stream with the audio stream from audio input port 108, and output the combined audio stream to the audio output port 110 as will be further described below with reference to FIGS. 2A-8C.

FIGS. 2A and 2B are block diagrams illustrating an example processing system 200 for the audio streaming devices 100a and 100b of FIGS. 1A and 1B. Processing system 200 includes the processor 104 and a machine-readable storage medium 106 (e.g., memory). Processor 104 is communicatively coupled to machine-readable storage medium 106 through the communication path 105. Although the following description refers to a single processor and a single machine-readable storage medium, the description may also apply to a system with multiple processors and multiple machine-readable storage mediums. In such examples, the instructions may be distributed (e.g., stored) across multiple machine-readable storage mediums and the instructions may be distributed (e.g., executed by) across multiple processors.

Processor 104 includes one (i.e., a single) central processing unit (CPU) or microprocessor or more than one (i.e., multiple) CPU or microprocessor, and/or other suitable hardware devices for retrieval and execution of instructions stored in machine-readable storage medium 106. Processor 104 may fetch, decode, and execute instructions 210-218 to operate an audio streaming device (e.g., 100a, 100b) including concealing missing audio data packets in a reconstructed audio stream.

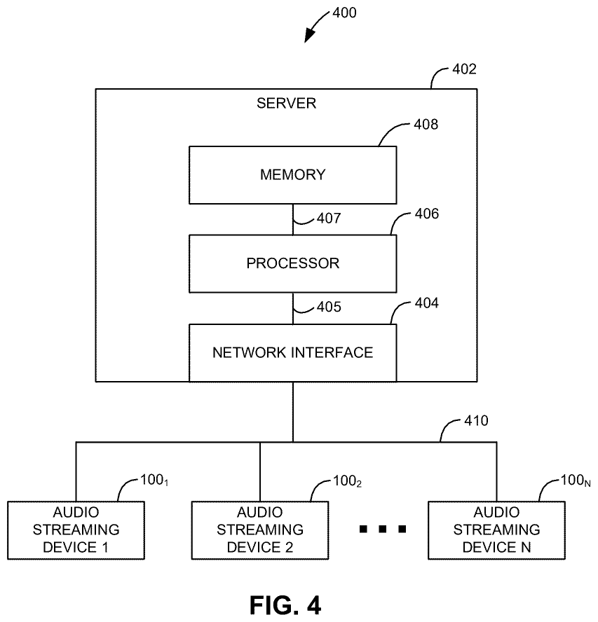

Processor 104 may fetch, decode, and execute instructions 210 to receive audio data packets from a further audio streaming device (e.g., 100₁ to 100_{N} described below with reference to FIG. 4), each audio data packet comprising an indicator (e.g., sequence number) of the position of the audio data packet within an audio stream. In some examples, each audio data packet may include compressed audio data. Using compression reduces the data rate and hence allows more time to reconstruct an audio stream. In some examples, the packet reconstruction disclosed herein may be performed in the compressed domain. Packet reconstruction performed in the compressed domain, however, may result in a larger gap in the signal as the compression ratio increases.

Processor 104 may fetch, decode, and execute instructions 212 to buffer the received audio data packets. Processor 104 may fetch, decode, and execute instructions 214 to reconstruct the audio stream based on the indicator of each buffered audio data packet. Processor 104 may fetch, decode, and execute instructions 216 to, prior to reconstructing the audio stream, identify whether there is a missing audio data packet within the audio stream based on the indicator of each buffered audio data packet (e.g., identify a missing packet in the buffered audio data packets). Processor 104 may fetch, decode, and execute instructions 218 to, in response to identifying a missing audio data packet, conceal the missing audio data packet to mitigate artifacts in the reconstructed audio stream.

In some examples, to conceal the missing audio data packet to mitigate artifacts in the reconstructed audio stream, the processor may be configured to fetch, decode, and execute further instructions to insert a filler audio data packet for the missing audio data packet where the filler audio data packet includes audio data indicating silence. Inserting silence may have a low impact on processor resources, but may include artifacts at the frame boundary similar to a buzz. In some examples, to conceal the missing audio data packet to mitigate artifacts in the reconstructed audio stream, the processor may be configured to fetch, decode, and execute further instructions to insert a filler audio data packet for the missing audio data packet where the filler audio data packet includes audio data indicating pseudo-random noise. Inserting pseudo-random noise may have a moderate impact on processor resources, but may include artifacts at the frame boundary. If the noise level is low enough, however, the chances of artifacts at the frame boundary making a buzz are reduced.

As illustrated in FIG. 2B, processor 104 may fetch, decode, and execute further instructions 220 to increase the size of the buffer to receive audio data packets in response to identifying a threshold number (e.g., 2, 3, 4, or more) of missing audio data packets. Processor 104 may fetch, decode, and execute further instructions 222 to request resending of each missing audio data packet. Increasing the size of the buffer may compensate for a poor network connection by increasing the allowable latency to increase (e.g., doubling, tripling, etc.) the amount of data buffered and hence provide time to request resending of problematic packets. In general, the data rate might be much faster than the audio rate for a given bandwidth, thus allowing multiple resend requests.

As further illustrated in FIG. 2B, processor 104 may fetch, decode, and execute further instructions 230 to receive an analog audio stream from the analog audio input port (e.g., 108 of FIG. 1B). Processor 104 may fetch, decode, and execute further instructions 232 to combine the analog audio stream with the reconstructed audio stream. Processor 104 may fetch, decode, and execute further instructions 234 to output the combined audio stream to the audio output port (e.g., 110 of FIG. 1B).

As an alternative or in addition to retrieving and executing instructions, processor 104 may include one (i.e., a single) electronic circuit or more than one (i.e., multiple) electronic circuits comprising a number of electronic components for performing the functionality of one of the instructions or more than one of the instructions in machine-readable storage medium 106. With respect to the executable instruction representations (e.g., boxes) described and illustrated herein, it should be understood that part or all of the executable instructions and/or electronic circuits included within one box may, in alternate examples, be included in a different box illustrated in the figures or in a different box not shown.

Machine-readable storage medium 106 is a non-transitory storage medium and may be any suitable electronic, magnetic, optical, or other physical storage device that stores executable instructions. Thus, machine-readable storage medium 106 may be, for example, a random access memory (RAM), an electrically-erasable programmable read-only memory (EEPROM), a storage drive, an optical disc, and the like. Machine-readable storage medium 106 may be disposed within system 200, as illustrated in FIGS. 2A and 2B. In this case, the executable instructions may be installed on system 200. Alternatively, machine-readable storage medium 106 may be a portable, external, or remote storage medium that allows system 200 to download the instructions from the portable/external/remote storage medium. In this case, the executable instructions may be part of an installation package.

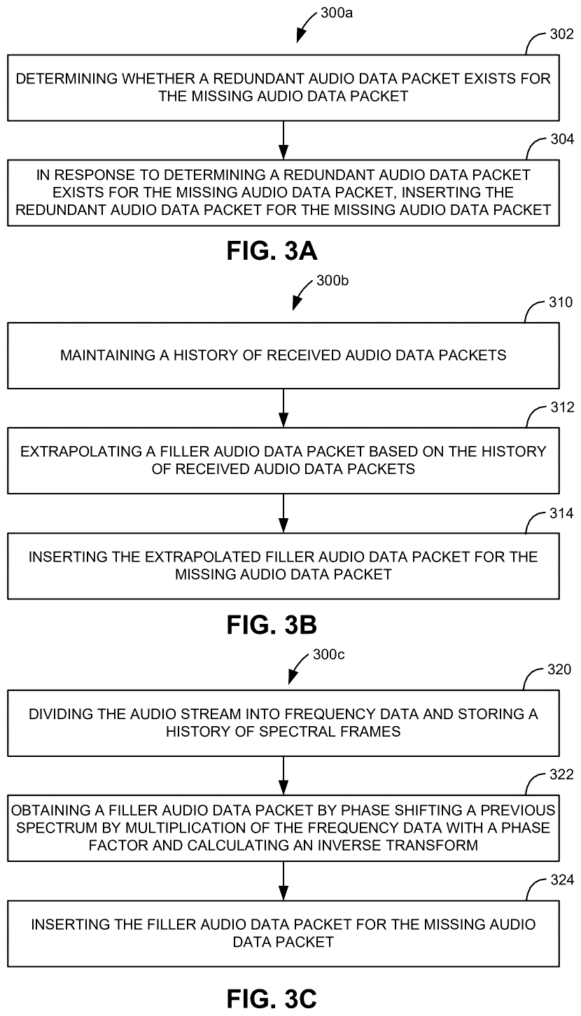

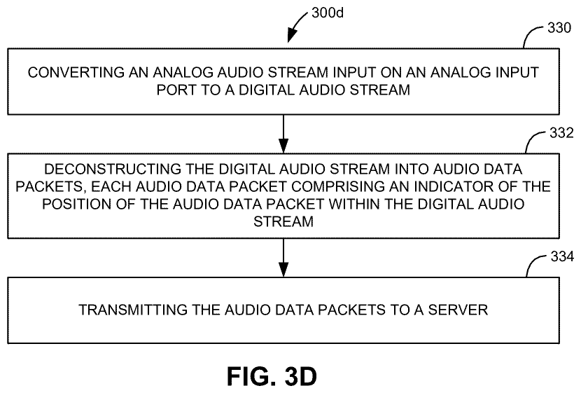

FIGS. 3A-3C are flow diagrams illustrating example methods 300a-300c for concealing missing audio data packets in a reconstructed audio stream. In some examples, methods 300a-300c are further instructions stored in machine-readable storage medium 106 configured to be executed by processor 104 to conceal a missing audio data packet to mitigate artifacts in the reconstructed audio stream as indicated at 218 of FIG. 2A.

In some examples, redundant audio data packets may be transmitted along with the audio data packets. In these examples, as illustrated in FIG. 3A at 302, method 300a includes determining whether a redundant audio data packet exists for the missing audio data packet. At 304, method 300a includes in response to determining a redundant audio data packet exists for the missing audio data packet, inserting the redundant audio data packet for the missing audio data packet.

As illustrated in FIG. 3B at 310, method 300b includes maintaining a history of received audio data packets. At 312, method 300b includes extrapolating a filler audio data packet based on the history of received audio data packets. In some examples, extrapolating the filler audio data packet based on the history of received audio data packets includes extrapolating a filler audio data packet via linear approximation and curve fitting (e.g., Burg Prediction). At 314, method 300b includes inserting the extrapolated filler audio data packet for the missing audio data packet. The history may be stored continuously to provide a desired window for the extrapolation. The window for the extrapolation may be selected to be long enough to capture low frequencies, yet short enough that past errors do not impact and degrade the approximation.

As illustrated in FIG. 3C at 320, method 300c includes dividing the audio stream into frequency data (e.g., via a Fast Fourier Transform, a Discrete Fourier Transform, or a perfectly reconstructing filter bank) and storing a history of spectral frames. At 322, method 300c includes obtaining a filler audio data packet by phase shifting a previous spectrum by multiplication of the frequency data with a phase factor and calculating an inverse transform. At 324, method 300c includes inserting the filler audio data packet for the missing audio data packet. The history may be stored continuously to provide a desired window for obtaining the filler audio data packet. The window may be selected to minimize pops and clicks in the reconstructed audio stream.

FIG. 3D is a flow diagram illustrating an example method 300d for generating an audio stream. In some examples, method 300d are further instructions stored in machine-readable storage medium 106 configured to be executed by processor 104. At 330, method 300d includes converting an analog audio stream input on the analog input port (e.g., 108 of FIG. 1B) to a digital audio stream. At 332, method 300d includes deconstructing the digital audio stream into audio data packets, each audio data packet comprising an indicator (e.g., sequence number) of the position of the audio data packet within the digital audio stream. At 334, method 300d includes transmitting the audio data packets to a server (e.g., to server 402 described below with reference to FIG. 4 via the network interface 102 of the audio streaming device).

FIG. 4 is a block diagram illustrating one example of a system 400 for concealing missing audio data packets in a reconstructed audio stream. System 400 includes a server 402 and a plurality (e.g., at least two) of audio streaming devices 100₁ to 100_{N}, where “N” is any suitable number of audio streaming devices. The plurality of audio streaming devices 100₁ to 100_{N} are communicatively coupled to the server 402 through a communication path 410 (e.g., Internet). Server 402 includes a network interface 404, a processor 406, and a memory 408. Processor 406 is communicatively coupled to the network interface 404 through a communication path 405 and to the memory 408 through a communication path 407.

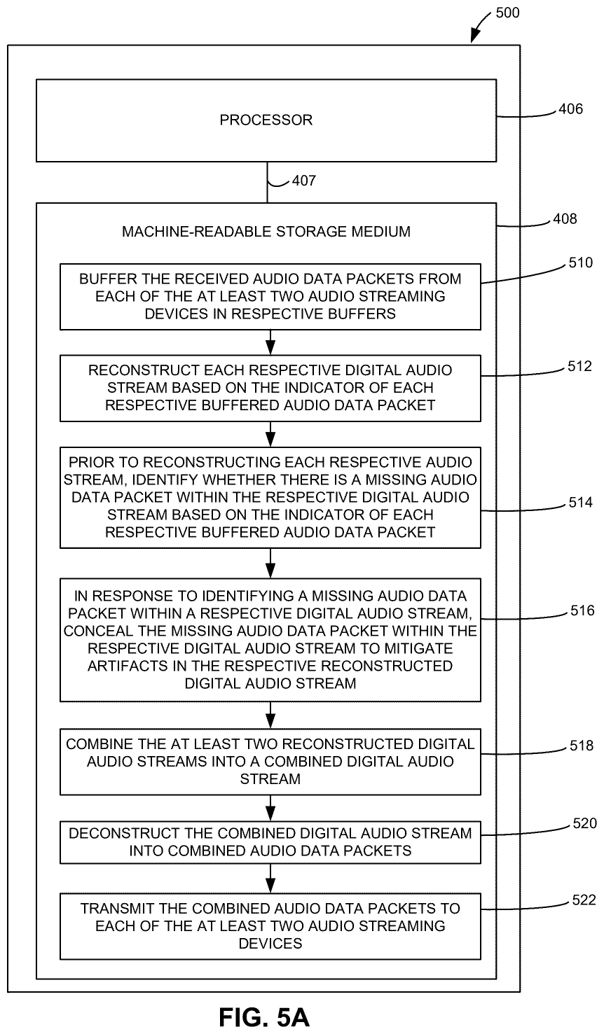

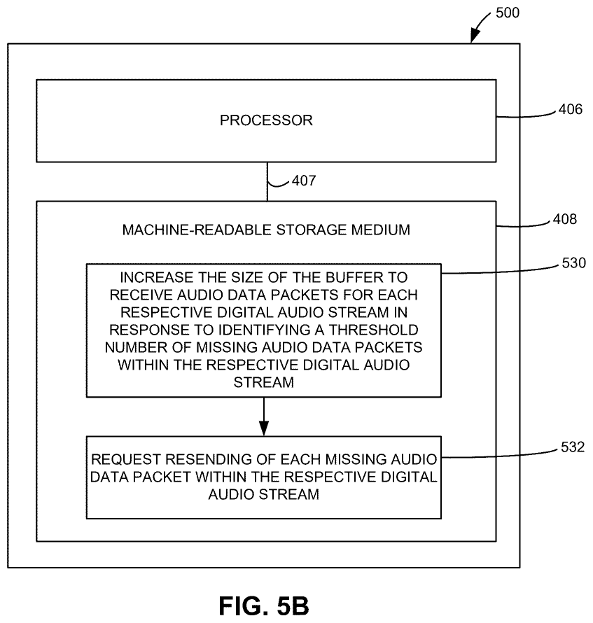

Network interface 404 is configured to connect the server 402 to a network (e.g., Local Area Network, Wide Area Network, Internet). In some examples, network interface 404 may be connected to the network via a cable, such as an Ethernet cable. The processor 406 and memory 408 may provide a processing system for controlling the operation of server 402 as will be described below with reference to FIGS. 5A and 5B.

Each audio streaming device 100₁ to 100_{N} might be an audio streaming device 100a or 100b as previously described and illustrated with reference to FIGS. 1A and 1B. Each audio streaming device 100₁ to 100_{N} is configured to transmit audio data packets for a respective digital audio stream to the server 402. Each audio data packet may include an indicator (e.g., sequence number) of the position of the audio data packet within the respective digital audio stream. Processor 406 of server 402 may combine multiple digital audio streams from at least two respective audio streaming devices 100₁ to 100_{N} and transmit the combined audio stream back to the at least two respective audio streaming devices 100₁ to 100_{N}.

FIGS. 5A and 5B are block diagrams illustrating an example processing system 500 for the server 402 of FIG. 4. Processing system 500 includes the processor 406 and a machine-readable storage medium 408 (e.g., memory). Processor 406 is communicatively coupled to machine-readable storage medium 408 through the communication path 407. Although the following description refers to a single processor and a single machine-readable storage medium, the description may also apply to a system with multiple processors and multiple machine-readable storage mediums. In such examples, the instructions may be distributed (e.g., stored) across multiple machine-readable storage mediums and the instructions may be distributed (e.g., executed by) across multiple processors.

Processor 406 includes one (i.e., a single) central processing unit (CPU) or microprocessor or more than one (i.e., multiple) CPU or microprocessor, and/or other suitable hardware devices for retrieval and execution of instructions stored in machine-readable storage medium 408. Processor 406 may fetch, decode, and execute instructions 510-522 to operate a server (e.g., 402) including concealing missing audio data packets in a reconstructed audio stream.

Processor 406 may fetch, decode, and execute instructions 510 to buffer the received audio data packets from each of the at least two audio streaming devices (e.g., 100₁ to 100_{N}) in respective buffers. In some examples, each audio data packet may include compressed audio data. Using compression reduces the data rate and hence allows more time to reconstruct an audio stream. In some examples, the packet reconstruction disclosed herein may be performed in the compressed domain. Packet reconstruction performed in the compressed domain, however, may result in a larger gap in the signal as the compression ratio increases.

Processor 406 may fetch, decode, and execute instructions 512 to reconstruct each respective digital audio stream based on the indicator of each respective buffered audio data packet. Processor 406 may fetch, decode, and execute instructions 514 to prior to reconstructing each respective audio stream, identify whether there is a missing audio data packet within the respective digital audio stream based on the indicator of each respective buffered audio data packet (e.g., identify a missing packet in the respective buffered audio data packets). Processor 406 may fetch, decode, and execute instructions 516 to in response to identifying a missing audio data packet within a respective digital audio stream, conceal the missing audio data packet within the respective digital audio stream to mitigate artifacts in the respective reconstructed digital audio stream.

In some examples, to conceal the missing audio data packet to mitigate artifacts in the respective reconstructed digital audio stream, processor 406 may fetch, decode, and execute further instructions to insert a filler audio data packet for the missing audio data packet within the respective digital audio stream where the filler audio data packet includes audio data indicating silence. Inserting silence may have a low impact on processor resources, but may include artifacts at the frame boundary similar to a buzz. In some examples, to conceal the missing audio data packet to mitigate artifacts in the reconstructed digital audio stream, processor 406 may fetch, decode, and execute further instructions to insert a filler audio data packet for the missing audio data packet within the respective digital audio stream where the filler audio data packet includes audio data indicating pseudo-random noise. Inserting pseudo-random noise may have a moderate impact on processor resources, but may include artifacts at the frame boundary. If the noise level is low enough, however, the chances of artifacts at the frame boundary making a buzz are reduced.

In some examples, methods 300a-300c previously described and illustrated with reference to FIGS. 3A-3C are further instructions stored in machine-readable storage medium 408 configured to be executed by processor 406 to conceal a missing audio data packet within a respective digital audio stream to mitigate artifacts in the respective reconstructed digital audio stream as indicated at 516 of FIG. 5A.

Processor 406 may fetch, decode, and execute instructions 518 to combine the at least two reconstructed digital audio streams into a combined digital audio stream. Processor 406 may fetch, decode, and execute instructions 520 to deconstruct the combined digital audio stream into combined audio data packets. Processor 406 may fetch, decode, and execute instructions 522 to transmit the combined audio data packets to each of the at least two audio streaming devices.

As illustrated in FIG. 5B, processor 406 may fetch, decode, and execute further instructions 530 to increase the size of the buffer to receive audio data packets for each respective digital audio stream in response to identifying a threshold number (e.g., 2, 3, 4, or more) of missing audio data packets within the respective digital audio stream. Processor 406 may fetch, decode, and execute further instructions 532 to request resending of each missing audio data packet within the respective digital audio stream. Increasing the size of the buffer may compensate for a poor network connection by increasing the allowable latency to increase (e.g., doubling, tripling, etc.) the amount of data buffered and hence provide time to request resending of problematic packets. In general, the data rate might be much faster than the audio rate for a given bandwidth, thus allowing multiple resend requests.

As an alternative or in addition to retrieving and executing instructions, processor 406 may include one (i.e., a single) electronic circuit or more than one (i.e., multiple) electronic circuits comprising a number of electronic components for performing the functionality of one of the instructions or more than one of the instructions in machine-readable storage medium 408. With respect to the executable instruction representations (e.g., boxes) described and illustrated herein, it should be understood that part or all of the executable instructions and/or electronic circuits included within one box may, in alternate examples, be included in a different box illustrated in the figures or in a different box not shown.

Machine-readable storage medium 408 is a non-transitory storage medium and may be any suitable electronic, magnetic, optical, or other physical storage device that stores executable instructions. Thus, machine-readable storage medium 408 may be, for example, a random access memory (RAM), an electrically-erasable programmable read-only memory (EEPROM), a storage drive, an optical disc, and the like. Machine-readable storage medium 408 may be disposed within system 500, as illustrated in FIGS. 5A and 5B. In this case, the executable instructions may be installed on system 500. Alternatively, machine-readable storage medium 408 may be a portable, external, or remote storage medium that allows system 500 to download the instructions from the portable/external/remote storage medium. In this case, the executable instructions may be part of an installation package.

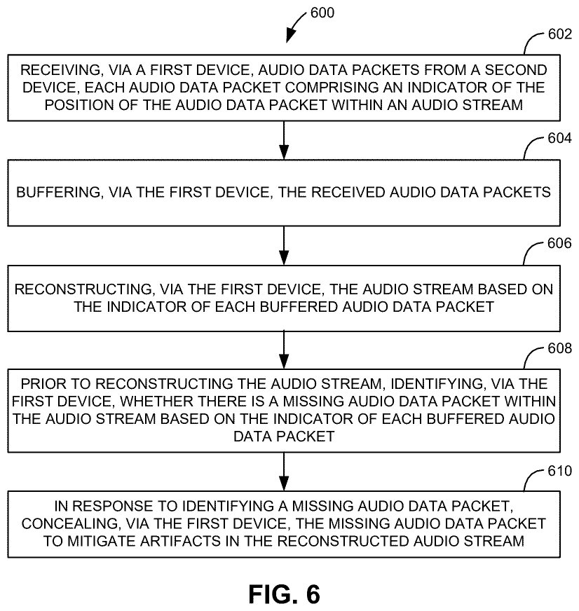

FIG. 6 is a flow diagram illustrating one example of a method 600 for concealing missing audio data packets in a reconstructed audio stream. In some examples, method 600 may be implemented by an audio streaming device 100a of FIG. 1A, 100b of FIG. 1B, or 100₁ to 100_{N} of FIG. 4, such as by a processing system 200 (FIGS. 2A and 2B) of the audio streaming device. In some examples, method 600 may be implemented by a server 402 of FIG. 4, such as by a processing system 500 (FIGS. 5A and 5B) of the server.

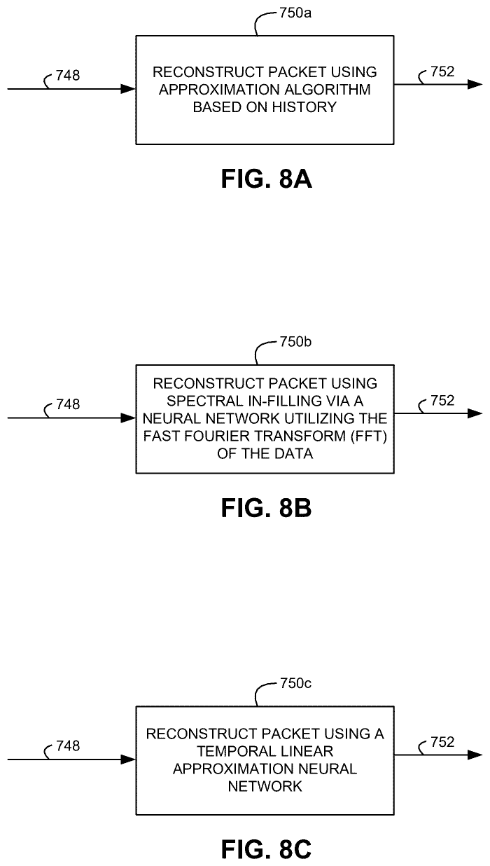

At 602, method 600 includes receiving, via a first device (e.g., one of an audio streaming device 100a, 100b, or 100₁ to 100_{N} or a server 402), audio data packets from a second device (e.g., another one of an audio streaming device 100a, 100b, or 100₁ to 100_{N} or a server 402), each audio data packet comprising an indicator (e.g., sequence number) of the position of the audio data packet within an audio stream. At 604, method 600 includes buffering, via the first device, the received audio data packets. At 606, method 600 includes reconstructing, via the first device, the audio stream based on the indicator of each buffered audio data packet. At 608, method 600 includes, prior to reconstructing the audio stream, identifying, via the first device, whether there is a missing audio data packet within the audio stream based on the indicator of each buffered audio data packet. At 610, method 600 includes, in response to identifying a missing audio data packet, concealing, via the first device, the missing audio data packet to mitigate artifacts in the reconstructed audio stream. As previously described, the missing audio data packet may be replaced with silence, pseudo-random noise, or a filler audio data packet obtained via linear approximation and curve fitting, a frequency domain approach, or another suitable process, such as by using a neural network as described below with reference to FIGS. 8B and 8C.

In some examples, the first device includes a first audio streaming device (e.g., one of an audio streaming device 100a, 100b, or 100₁ to 100_{N}) and the second device includes a second audio streaming device (e.g., another one of an audio streaming device 100a, 100b, or 100₁ to 100_{N}). In other examples, the first device includes an audio streaming device (e.g., one of an audio streaming device 100a, 100b, or 100₁ to 100_{N}) and the second device includes a server (e.g., 402). In yet other examples, the first device includes a server (e.g., 402) and the second device includes an audio streaming device (e.g., one of an audio streaming device 100a, 100b, or 100₁ to 100_{N}).

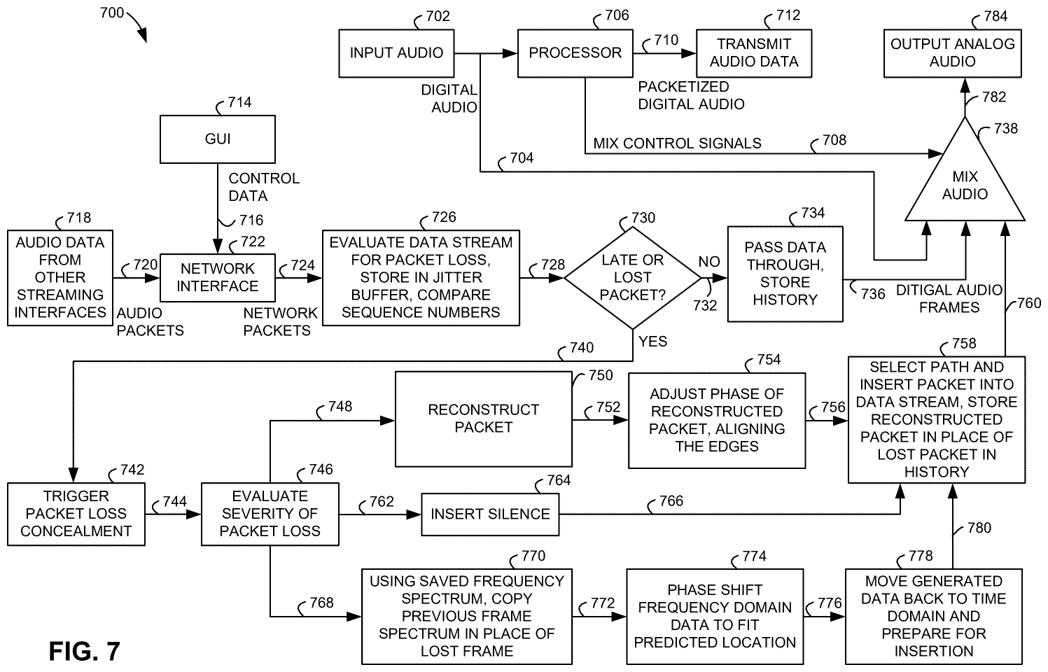

FIG. 7 is a functional block diagram illustrating one example of a system 700 for concealing missing audio data packets in a reconstructed audio stream. At 702, input audio (e.g., from a musical instrument, microphone, etc.) is received, such as via an audio input port 108 of an audio streaming device 100b of FIG. 1B. If the input audio is analog audio, the analog audio might be converted to digital audio at 702 and passed to communication path 704. If the input audio is digital audio, the digital audio might be passed to communication path 704. The digital audio on communication path 704 is received by a processor at 706, such as a processor 104 of the audio streaming device 100b. The processor at 706 may packetize the digital audio for transmission over a network (e.g., Internet) and pass the packetized digital audio through a communication path 710 to transmit the packetized digital audio at 712. The audio data may be transmitted at 712 by a network interface 102 of the audio streaming device 100b. The digital audio on communication path 704 is also passed to a first input of an audio mixer at 738. Audio mixer control signals may be generated by the processor at 706 and passed to a control input of the audio mixer 738 through a communication path 708.

Audio data from other streaming interfaces (e.g., from an audio streaming device 100₁ to 100_{N} or from a server 402) at 718 is passed through a communication path 720 (e.g., Internet) to a network interface at 722. The network interface at 722 might be the network interface 102 of the audio streaming device 100b. A graphical user interface (GUI) at 714 may be used to generate control data and pass the control data through a communication link 716 (e.g., Internet) to the network interface at 722. The control data may control the routing of audio inputs to the audio streaming device. The network interface at 722 passes the network packets through a communication path 724 to evaluate the data stream for packet loss, store the packets in a jitter buffer, and compare sequence numbers of the packets at 726. In some examples, the components/processes 726-782 are implemented via a processor 104 of the audio streaming device 100b. The result of the evaluation at 726 on communication path 728 is checked to determine whether there is a late or lost packet at 730. In response to there not being a late or lost packet as indicated at 732, the data passes through and the history is stored at 734. The digital audio frames are then passed through a communication path 736 to a second input of the audio mixer 738.

In response to there being a late or lost packet as indicated at 740, packet loss concealment is triggered at 742 and the data is passed at 744 to evaluate the severity of the packet loss at 746. Based on the evaluation, in this example, one of three options may be selected for packet loss concealment. The data may be passed at 748 to reconstruct the packet at 750 as further described below with reference to FIGS. 8A-8C. The reconstructed packet is then passed at 752 to adjust the phase of the reconstructed packet, aligning the edges at 754.

The data may be passed at 762 to insert silence at 764. The data may be passed at 768 to, using a saved frequency spectrum, copy the previous frame spectrum in place of the lost frame at 770 (e.g., as described with reference to FIG. 3C). The previous frame spectrum is passed at 772 to phase shift the frequency domain data to fit the predicted location at 774. The phase shifted frequency domain data is passed at 776 to move the generated data back to the time domain and prepare for insertion of the packet at 778. At 758, a path 756 with a reconstructed packet, 766 with a packet indicating silence, or 780 with a reconstructed packet is selected and the selected packet is inserted into the data stream and the reconstructed packet is stored in place of the lost packet in the history. The digital audio frames are then passed to a third input of audio mixer 738 through a communication path 760. In some examples, the reconstructed packet at 756 and/or the reconstructed packet at 780 may each be checked to determine an error level of the reconstructed packet. If the error level exceeds a limit or the history is of poor quality (e.g., includes many lost packets), the packet indicating silence at 766 may be selected at 758.

Based on the mix control signals on communication path 708, audio mixer 738 mixes the digital audio on communication path 704 with either the digital audio frames on communication path 736 (when a packet is not lost) or with the digital audio frames on communication path 760 (when a packet is lost and reconstructed). The mixed digital audio is converted to analog audio and then passed through a communication path 782 to output analog audio at 784, such as via an audio output port 110 of the audio streaming device 100b.

FIGS. 8A-8C are block diagrams illustrating example systems and/or methods for reconstructing a packet at 750 in system 700 of FIG. 7. In some examples as illustrated in FIG. 8A, the data may be passed at 748 to reconstruct the packet at 750a using an approximation algorithm based on the history (e.g., as described with reference to FIG. 3B). The reconstructed packet is then passed at 752 to adjust the phase of the reconstructed packet, aligning the edges at 754 of FIG. 7.

In some examples as illustrated in FIG. 8B, the data may be passed at 748 to reconstruct the packet at 750b using spectral in-filling via a neural network utilizing the Fast Fourier Transform (FFT) of the data. The reconstructed packet is then passed at 752 to adjust the phase of the reconstructed packet, aligning the edges at 754 of FIG. 7. The neural network may be trained as a Generative Adversarial Network that learns how to linearly interpolate missing audio data in the frequency domain. Datasets used to train the neural network may be any amount of either open source or proprietary audio recording files that encompass a high dynamic range.

In some examples as illustrated in FIG. 8C, the data may be passed at 748 to reconstruct the packet at 750c using a temporal linear approximation neural network. The reconstructed packet is then passed at 752 to adjust the phase of the reconstructed packet, aligning the edges at 754 of FIG. 7. The neural network may be trained as a Generative Adversarial Network that learns how to linearly interpolate missing audio data in the time domain. Datasets used to train the neural network may be any amount of either open source or proprietary audio recording files that encompass a high dynamic range.

The systems, devices, and processes disclosed herein enable musicians to collaborate in real time over a network and keep time with each other while playing live music. By concealing missing audio data packets within an audio stream to mitigate artifacts in the reconstructed digital audio stream, temporal gaps leading to audible pops, clicks, or other artifacts may be reduced or eliminated.

Although specific examples have been illustrated and described herein, a variety of alternate and/or equivalent implementations may be substituted for the specific examples shown and described without departing from the scope of the present disclosure. This application is intended to cover any adaptations or variations of the specific examples discussed herein. Therefore, it is intended that this disclosure be limited only by the claims and the equivalents thereof.

1. An audio streaming device comprising:
a network interface;
a memory storing instructions; and
a processor communicatively coupled to the network interface and the memory, the processor configured to execute the instructions to:
receive audio data packets from a further audio streaming device, each audio data packet comprising an indicator of the position of the audio data packet within an audio stream;
buffer the received audio data packets;
reconstruct the audio stream based on the indicator of each buffered audio data packet;
prior to reconstructing the audio stream, identify whether there is a missing audio data packet within the audio stream based on the indicator of each buffered audio data packet; and
in response to identifying a missing audio data packet, conceal the missing audio data packet to mitigate artifacts in the reconstructed audio stream.

2. The audio streaming device of claim 1, wherein to conceal the missing audio data packet to mitigate artifacts in the reconstructed audio stream, the processor is configured to execute the instructions to:
determine whether a redundant audio data packet exists for the missing audio data packet; and
in response to determining a redundant audio data packet exists for the missing audio data packet, inserting the redundant audio data packet for the missing audio data packet.

3. The audio streaming device of claim 1, wherein to conceal the missing audio data packet to mitigate artifacts in the reconstructed audio stream, the processor is configured to execute the instructions to:
maintain a history of received audio data packets;
extrapolate a filler audio data packet based on the history of received audio data packets; and
insert the extrapolated filler audio data packet for the missing audio data packet.

4. The audio streaming device of claim 3, wherein to extrapolate the filler audio data packet based on the history of received audio data packets, the processor is configured to execute the instructions to extrapolate a filler audio data packet via linear approximation and curve fitting.

5. The audio streaming device of claim 1, wherein to conceal the missing audio data packet to mitigate artifacts in the reconstructed audio stream, the processor is configured to execute the instructions to:
divide the audio stream into frequency data and store a history of spectral frames;
obtain a filler audio data packet by phase shifting a previous spectrum by multiplication of the frequency data with a phase factor and calculating an inverse transform; and
insert the filler audio data packet for the missing audio data packet.

6. The audio streaming device of claim 1, wherein to conceal the missing audio data packet to mitigate artifacts in the reconstructed audio stream, the processor is configured to execute the instructions to:
insert a filler audio data packet for the missing audio data packet, the filler audio data packet comprising audio data indicating silence.

7. The audio streaming device of claim 1, wherein to conceal the missing audio data packet to mitigate artifacts in the reconstructed audio stream, the processor is configured to execute the instructions to:
insert a filler audio data packet for the missing audio data packet, the filler audio data packet comprising audio data indicating pseudo-random noise.

8. The audio streaming device of claim 1, wherein the processor is configured to execute the instructions to:
increase the size of the buffer to receive audio data packets in response to identifying a threshold number of missing audio data packets; and
request resending of each missing audio data packet.

9. The audio streaming device of claim 1, wherein each audio data packet comprises compressed audio data.

10. The audio streaming device of claim 1, further comprising:
an audio output port;
wherein the processor is configured to execute the instructions to output the reconstructed audio stream to the audio output port.

11. The audio streaming device of claim 10, further comprising:
an analog audio input port;
wherein the processor is configured to execute the instructions to:
receive an analog audio stream from the analog audio input port;
combine the analog audio stream with the reconstructed audio stream; and
output the combined audio stream to the audio output port.

12. A system comprising:
a server; and
at least two audio streaming devices communicatively coupled to the server, each audio streaming device configured to transmit audio data packets for a respective digital audio stream to the server, each audio data packet comprising an indicator of the position of the audio data packet within the respective digital audio stream;
wherein the server is configured to:
buffer the received audio data packets from each of the at least two audio streaming devices in respective buffers;
reconstruct each respective digital audio stream based on the indicator of each respective buffered audio data packet;
prior to reconstructing each respective audio stream, identify whether there is a missing audio data packet within the respective digital audio stream based on the indicator of each respective buffered audio data packet;
in response to identifying a missing audio data packet within a respective digital audio stream, conceal the missing audio data packet within the respective digital audio stream to mitigate artifacts in the respective reconstructed digital audio stream;
combine the at least two reconstructed digital audio streams into a combined digital audio stream;
deconstruct the combined digital audio stream into combined audio data packets; and
transmit the combined audio data packets to each of the at least two audio streaming devices.

13. The system of claim 12, wherein to conceal the missing audio data packet to mitigate artifacts in the respective reconstructed audio stream, the server is configured to:
determine whether a redundant audio data packet exists for the missing audio data packet within the respective digital audio stream; and
in response to determining a redundant audio data packet exists for the missing audio data packet within the respective digital audio stream, inserting the redundant audio data packet for the missing audio data packet within the respective digital audio stream.

14. The system of claim 12, wherein to conceal the missing audio data packet to mitigate artifacts in the respective reconstructed audio stream, the sever is configured to:
maintain a history of received audio data packets for each respective digital audio stream;
extrapolate a filler audio data packet based on the history of received audio data packets for the respective digital audio stream; and
insert the extrapolated filler audio data packet for the missing audio data packet within the respective digital audio stream.

15. The system of claim 14, wherein to extrapolate the filler audio data packet based on the history of received audio data packets for the respective digital audio stream, the server is configured to extrapolate a filler audio data packet via linear approximation and curve fitting.

16. The system of claim 12, wherein to conceal the missing audio data packet to mitigate artifacts in the reconstructed audio stream, the server is configured to:
divide the respective digital audio stream into frequency data and store a history of spectral frames for the respective digital audio stream;
obtain a filler audio data packet by phase shifting a previous spectrum for the respective digital audio stream by multiplication of the frequency data with a phase factor and calculating an inverse transform; and
insert the filler audio data packet for the missing audio data packet within the respective digital audio stream.

17. The system of claim 12, wherein to conceal the missing audio data packet to mitigate artifacts in the reconstructed audio stream, the server is configured to:
insert a filler audio data packet for the missing audio data packet within the respective digital audio stream, the filler audio data packet comprising audio data indicating silence.

18. The system of claim 12, wherein to conceal the missing audio data packet to mitigate artifacts in the reconstructed audio stream, the server is configured to:
insert a filler audio data packet for the missing audio data packet within the respective digital audio stream, the filler audio data packet comprising audio data indicating pseudo-random noise.

19. The system of claim 12, wherein the server is configured to:
increase the size of the buffer to receive audio data packets for each respective digital audio stream in response to identifying a threshold number of missing audio data packets within the respective digital audio stream; and
request resending of each missing audio data packet within the respective digital audio stream.

20. The system of claim 12, wherein each audio data packet comprises compressed audio data.

21. The system of claim 12, wherein each audio streaming device comprises:
an analog input port; and
a processor configured to:
convert an analog audio stream input on the analog input port to a digital audio stream;
deconstruct the digital audio stream into audio data packets, each audio data packet comprising an indicator of the position of the audio data packet within the digital audio stream; and
transmit the audio data packets to the server.

22. A method comprising:
receiving, via a first device, audio data packets from a second device, each audio data packet comprising an indicator of the position of the audio data packet within an audio stream;
buffering, via the first device, the received audio data packets;
reconstructing, via the first device, the audio stream based on the indicator of each buffered audio data packet;
prior to reconstructing the audio stream, identifying, via the first device, whether there is a missing audio data packet within the audio stream based on the indicator of each buffered audio data packet; and
in response to identifying a missing audio data packet, concealing, via the first device, the missing audio data packet to mitigate artifacts in the reconstructed audio stream.

23. The system of claim 22, wherein the first device comprises a first audio streaming device and the second device comprises a second audio streaming device.

24. The system of claim 22, wherein the first device comprises an audio streaming device and the second device comprises a server.

25. The system of claim 22, wherein the first device comprises a server and the second device comprises an audio streaming device.
